(19) United States
(12) Patent Application Publication
(10) Pub. No.: US 2022/0074482 A1
(43) Pub. Date: Mar. 10, 2022

(54) PARTICLE CATCHER AND AXLE ASSEMBLY COMPRISING SAME

(71) Applicant: Donaldson Company, Inc., Minneapolis, MN (US)

(72) Inventors: Enrico GRECO, Villa Poma di Borgo Montavano (IT); Fabrizio BURATTO, Sustinente, Mantova (IT)

(73) Assignee: Donaldson Company, Inc., Minneapolis, MN (US)

(21) Appl. No.: 17/298,130

(22) PCT Filed: Nov. 27, 2019
(86) PCT No.: PCT/US2019/063670

§ 371 Date: May 28, 2021

Related U.S. Application Data
(60) Provisional application No. 62/773,779, filed on Nov. 30, 2018.

(51) Int. Cl. F16H 57/04; B01D 35/153; B01D 35/06; B01D 29/50; B01D 46/00; B01D 46/42; B60B 35/16; F16N 39/06

(52) U.S. Cl. CPC F16H 57/0404; B01D 35/153; B01D 35/06; B01D 29/50; B01D 46/0019; B01D 2265/029; B01D 46/0034; B60B 35/16; F16N 39/06; B01D 2201/167; B01D 2201/4092; B01D 46/4272

(57) ABSTRACT

A panicle catcher for capturing entrained particles in a fluid is disclosed. The particle catcher can include an enclosure defining a flow channel between an inlet and an outlet. Trapping means may be incorporated into the particle catcher. Where provided, the trapping means can be arranged at or near the inlet to allow fluid comprising entrained particles to enter the flow channel through the inlet and to substantially prevent the fluid comprising entrained particles from exiting the flow channel through the inlet. Filtering means may also be incorporated into the particle catcher. Where provided, the filtering means can be arranged at or near the outlet to keep at least some a part of the entrained particles from exiting the flow channel through the outlet.

### RELATED APPLICATION

This application is being filed on Nov. 27, 2019, as a PCT International Patent application and claims priority to U.S. Provisional patent application Ser. No. 62/773,779, filed Nov. 30, 2018, the entire disclosure of which is incorporated by reference in its entirety.

### FIELD OF THE INVENTION

The present invention pertains to the field of filtration, in particular to a system for removing particles from a fluid flow such as the entrained fluid flow inside an axle housing.

### BACKGROUND

During operation of an axle, small quantities of solid metal and/or plastic that are broken or shaved off of parts due to normal “wear and tear” accumulate in the axle housing. These particles negatively affect the lifespan of the parts inside the axle assembly. It is quite expensive and cumbersome to periodically disassemble the axle assembly to remove the debris.

There is a need for a solution that deals with such debris in a more efficient manner.

### SUMMARY

According to an aspect of the present invention, there is provided a particle catcher comprising an enclosure defining a flow channel between an inlet and an outlet. The particle catcher can further including: trapping means arranged at or near the inlet to allow a fluid including entrained particles to enter the flow channel through the inlet and to substantially prevent the fluid comprising entrained particles from exiting the flow channel through the inlet; and filtering means arranged at or near the outlet to keep at least some a part of the entrained particles from exiting the flow channel through the outlet.

The trapping means may in particular be a one-way valve or an element that fulfills the function of a one-way valve. Examples of trapping means are provided hereinbelow. The filtering means may in particular be a filter or an element that fulfills the function of a filter. Examples of filtering means are provided hereinbelow.

Throughout the present application, the term “fluid” may be understood as a liquid (including a lubricant such as oil or automatic transmission fluid, ATF) or a gas (including regular air, air with small amounts of other gases or vapors in it, or any other gas).

It is an advantage of the present invention that it can be used to passively remove unwanted particles from an environment in situations where there is already a fluid flow having, at least locally, a predominant direction.

In an embodiment, the particle catcher according to the present invention further comprises a reservoir for containing particles extracted from said fluid comprising entrained particles by said filtering means.

The accumulation of extracted particles in the main body of the enclosure may over time increase the flow resistance of the flow channel. It is an advantage of this embodiment that the extracted particles are accumulated in a reservoir which is at least partially shielded from the remainder of the enclosure, thus ensuring substantially unimpeded flow of the incoming fluid throughout the usage of the particle catcher.

In an embodiment, the particle catcher according to the present invention further comprises a magnetized element arranged to extract and immobilize particles comprising paramagnetic and/or ferromagnetic materials from said fluid comprising entrained particles.

This embodiment is inter alia based on the insight of the inventors that a significant fraction of the debris appearing in heavy machinery with moving parts consists of fragments or shavings of iron or steel parts, which are thus substantially made of a ferromagnetic material. Hence, applying a magnetic field is a suitable way to deflect those fragments from the fluid stream and subsequently hold them in place inside the particle catcher.

The magnetized element may be a separate magnet arranged in the enclosure or in the reservoir (if present), or it may be a portion of the enclosure or reservoir (if present) that is suitably magnetized (where the enclosure or the reservoir, or the relevant part thereof, is made of a ferromagnetic material).

As the extracted particles comprising paramagnetic and/or ferromagnetic materials will be attracted by the magnetized elements, they will be held in place there, which keeps them from clogging the filtering means.

In an embodiment of the particle catcher according to the present invention, the trapping means comprises a grid covering the cross-section of the flow channel, a fixed support, and a flap arranged to be movable between a closed position whereby it seals off the grid and an open position whereby it rests against the fixed support.

A hinged flap is a particularly efficient way to provide a one-way valve or trap in the sense of the present application.

In a particular embodiment, the fixed support is formed by a wall of the reservoir.

This arrangement allows for a particularly compact implementation of the particle catcher.

In an embodiment of the particle catcher according to the present invention, the filtering means comprises a screen, a mesh, or a sheet of non-woven material.

The type of filtering structure may be chosen by the person skilled in the art in function of the size of the particles that are to be filtered out of the fluid flow.

In an embodiment of the particle catcher according to the present invention, the enclosure comprises at least one removable part situated so as to provide access to the reservoir.

It is an advantage of this embodiment that the reservoir can easily be emptied whenever the system in which it is deployed is being serviced.

In a particular embodiment, the removable part is secured by a screw or a bolt.

This type of attachment means provides a reliable attachment even when the removable part is removed and reattached repeatedly.

In an embodiment of the particle catcher according to the present invention, the enclosure has a substantially elongate shape from the inlet to the outlet.

It is an advantage of the substantially elongate shape, in particular when arranged with the long axis aligned with the (local) direction of fluid flow, that it minimizes the interference with the overall fluid flow. The elongate form factor also allows for a generally compact housing which, in the context of lubricant-based application such as an axle, does not interfere with the lubricant reaching bearings and gears.

In a particular embodiment, the enclosure is defined by at least a first cylindrically curved wall portion and a second cylindrically curved wall portion, the first cylindrically curved wall portion having a greater radius of curvature than the second cylindrically curved wall portion.

The implementation in the form of a curved or bent box makes the particle catcher particularly suited for use inside a cylindrical housing, which is typical for housings that mainly comprise a rotating part.

In a particular embodiment, the first cylindrically curved wall portion is shaped so as to allow internal engagement with a cylindrical portion of an axle housing.

In an embodiment, the particle catcher according to the present invention further comprises a bracket adapted to attach the enclosure to an inside of an axle housing in an orientation whereby the inlet is directed towards an upstream side of a prevailing fluid flow in the inside of the axle housing.

The invention is particularly suited for use inside an axle housing, where the movement of the axle during the normal operation of the vehicle on which the axle housing is mounted, causes an entrained fluid stream (in particular, a “jet” of lubricant) that may be filtered by means of the particle catcher according to the invention.

According to an aspect of the present invention, there is provided an axle assembly comprising: an axle housing; an axle rotatably arranged in the axle housing; and at least one particle catcher as described above, arranged in an orientation whereby the inlet is directed towards an upstream side of a prevailing fluid flow in the inside of the axle housing.

In case more than one particle catcher is used, the particle catchers may have different filtering properties. For example, the particle catchers may be arranged one after the other in the direction of fluid flow, whereby consecutive particle catchers (as seen in the direction of fluid flow) have incrementally tighter filtering means, such that larger particles are extracted first and smaller particles are extracted subsequently.

The technical effects and advantages of embodiments of the axle assembly according to the present invention correspond, mutatis mutandis, to those of the corresponding embodiments of the particle catcher according to the present invention.

According to an aspect of the present invention, there is provided a particle catcher including an enclosure defining a flow channel extending between an inlet and an outlet, a one-way valve located within the flow channel proximate the inlet, the one-way valve allowing a fluid comprising entrained particles to enter the flow channel through the inlet and preventing the fluid comprising entrained particles from exiting the flow channel through the inlet, and a filter, arranged within the flow channel proximate the outlet to keep at least some of the entrained particles from exiting the flow channel through the outlet.

In a particular embodiment, wherein the enclosure has a pair of curved wall portions at least partially defining the flow channel.

In a particular embodiment, the particle catcher further includes a reservoir for containing particles extracted from the fluid comprising entrained particles by said filter.

In a particular embodiment, the particle catcher further includes a magnetized element arranged to extract and immobilize some or all of the entrained particles.

In a particular embodiment, the one-way valve includes a grid covering a cross-section of the flow channel, a fixed support, and a flap arranged to be movable between a closed position whereby the flap seals off the grid and an open position whereby the flap rests against the fixed support.

According to an aspect of the present invention, there is provided an axle assembly including an axle housing and an axle rotatably arranged in the axle housing, and at least one particle catcher. The particle catcher can include an enclosure defining a flow channel, a one-way valve located within the flow channel, and a filter arranged within the flow channel downstream of the one-way valve. In one aspect, the particle catcher is arranged in an orientation such that the inlet is directed towards an upstream side of a prevailing fluid flow in the inside of the axle housing.

In a particular embodiment, the particle catcher of the axle assembly includes a plurality of particle catchers.

### BRIEF DESCRIPTION OF THE FIGURES

These and other features and advantages of embodiments of the present invention will be described in more detail with reference to the accompanying drawings, in which:

FIG. 1 is a perspective drawing of a closed axle housing;

FIG. 2 is a perspective drawing of an axle assembly, without the housing, equipped with a particle catcher according to an embodiment of the present invention;

FIG. 3 is a plan view of a particle catcher according to an embodiment of the present invention, as seen from the side of the inlet;

FIG. 4 is a plan view of the embodiment of FIG. 3, as seen from a lateral side;

FIG. 5 is a plan view of the embodiment of FIG. 3, as seen from the side of the outlet0; and

FIG. 6 is a partly exploded perspective view of a particle catcher according to an embodiment of the present invention.

Throughout the figures, like numerals have been used for the same or similar elements.

### DETAILED DESCRIPTION

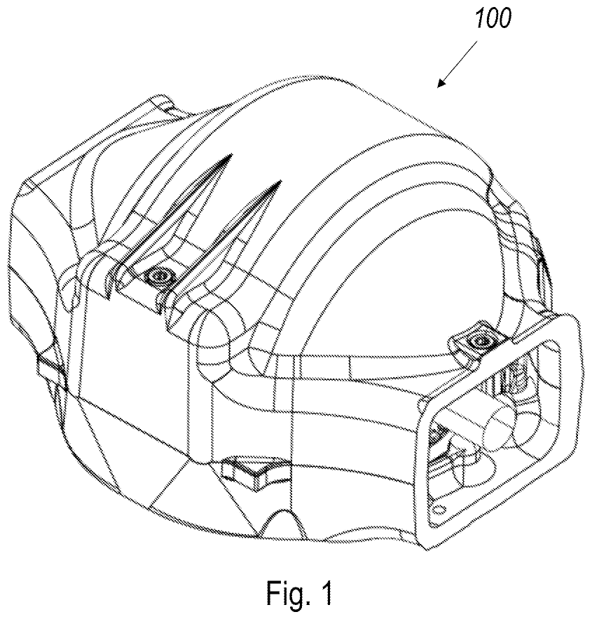

As embodiments of the particle catcher according to the present invention are particularly suited for use as a debris filter in an axle housing, the term “axle debris filter” will be used hereinafter interchangeably with the term “particle catcher”. In the context of motor vehicles, including as heavy-duty vehicles, the term “axle” typically is loosely used to refer to the assembly of the actual shaft(s) which rotate(s) with the wheel(s) and the housing in which they are situated, possibly also including other components; in the case of a drive axle, a pinion—crown wheel combination and a differential may be included. To avoid ambiguity, the term “axle” will be used hereinafter to refer to the shaft itself, and the term “axle housing” will be used to refer to the housing containing the actual axle. An axle housing of this kind is shown in FIG. 1.

The term “axle debris” refers to any particles or impurities that may be present inside the axle housing, the trapping of which is envisaged by embodiments of the present invention. In the context of an axle, at least some of the fluid inside the axle housing will be brought into a rotating flow as a result of the rotation of the axle and associated parts during normal movement of the vehicle. In the context of an axle, the fluid, as referred to hereinafter, will typically be a lubricant, such as an oil, with a preferred kinematic viscosity according to SAE 75W-80 and 80W-140.

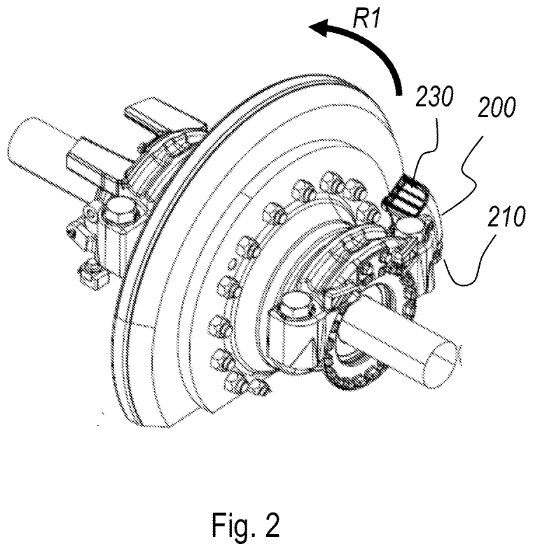

FIG. 2 illustrates an axle assembly comprising an axle housing 100; an axle rotatably arranged in the axle housing, and a particle catcher 200, as will be described in more detail below.

Without loss of generality, the direction of the axle during forward movement of the vehicle may be designated as the primary rotation direction, as forward movement is the expected movement during operation of a vehicle intended for transportation of goods or persons. While is understood that some vehicular equipment is used for groundworks, whereby the operation may be characterized by repetitive back-and-forth movements rather than long stretches of forward movement, the forward movement may still be used to define the primary rotation direction of the axle for the purpose of the present invention.

As a further result of the movement of the axle, particles will float around in the axle housing as they are entrained by the rotating fluid flow.

It should be noted that where the fluid is air or a similar gas, heavier particles may in some cases seem to follow a substantially ballistic (free-fall) trajectory upon coming into contact with a rotating part, which launches them in the direction of the rotation. Such particles may also be considered as entrained particles for the purposes of this description.

The axle of FIG. 2 has a primary rotation direction as defined above, indicated by the curved arrow R1. The particle catcher 200 is preferably arranged in an orientation whereby its inlet 210 is directed towards the upstream side of the prevailing fluid flow in the inside of the axle housing 100, as determined by the primary rotation direction. Conversely, the outlet 230 is directed to the downstream side of the prevailing fluid flow. Optionally, the particle catcher 200 may be oriented so that the inlet points substantially downwards when the vehicle is oriented in its normal operating position.

For vehicles that have more than one working direction, such as vehicular equipment used for groundworks as mentioned above, it is advantageous to provide at least two particle catchers, whereby at least a first particle catcher (or a first set of particle catchers) is oriented with its inlet towards the upstream side of the prevailing fluid flow when the vehicle is moving in one direction, and at least a second particle catcher (or a second set of particle catchers) is oriented with its inlet towards the upstream side of the prevailing fluid flow when the vehicle is moving in the other direction. The first particle catcher and the second particle catcher may for example be arranged in mirrored positions relative to the vertical plane that contains the axis of the axle.

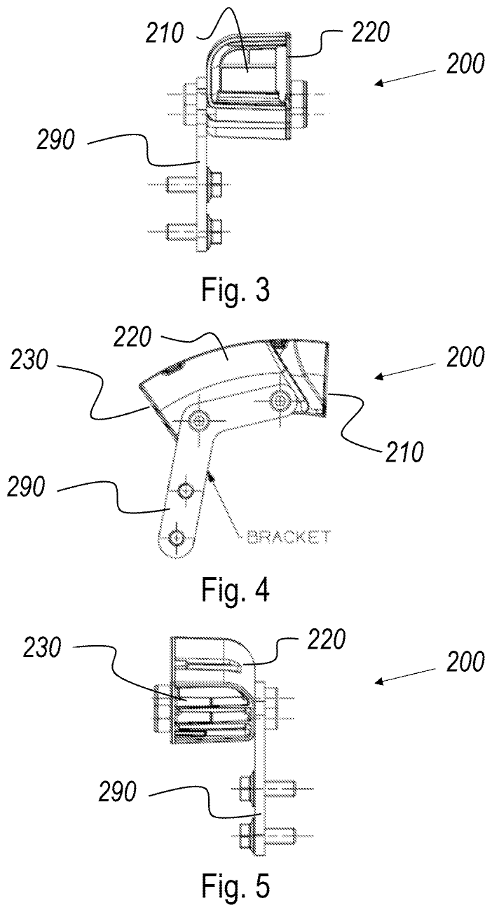

FIGS. 3-5 provided detailed views of a particle catcher according to an embodiment of the present invention, as seen from the side of the inlet, a lateral side, and the side of the outlet, respectively.

The particle catcher 200 comprises an enclosure 220 defining a flow channel between an inlet 210 and an outlet 230.

The inlet 210 is permeable to a fluid comprising entrained particles, such that a part of a fluid stream with particles can enter the enclosure 220 through the inlet 210. The outlet 230 is permeable to the fluid when devoid of the targeted entrained particles, such that a fluid flow through the enclosure 220 is possible, whereby at least some of the particles are caught inside the enclosure 220.

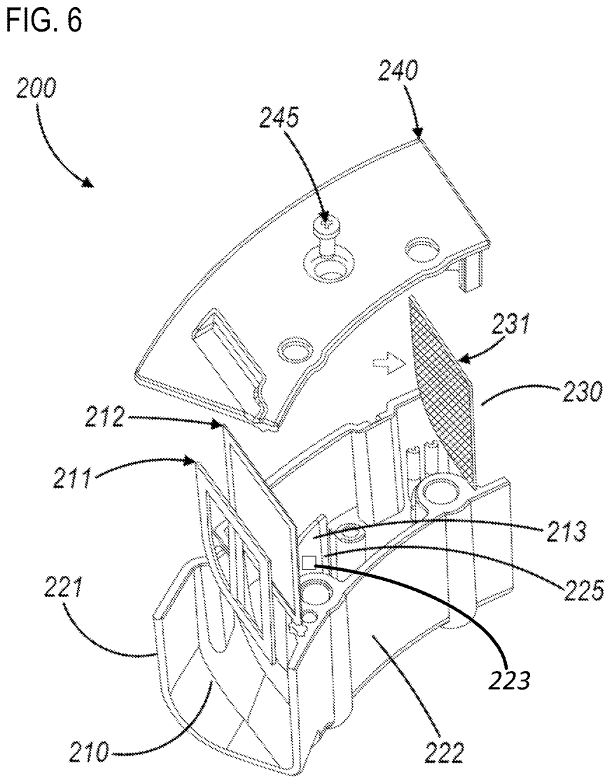

To this end, the particle catcher 200 further comprises trapping means arranged at or near the inlet 210 to allow a fluid comprising entrained particles to enter the flow channel through the inlet 210 while also being arranged to substantially prevent the fluid comprising entrained particles from exiting the flow channel through the inlet 210; the trapping means thus forms a one-way valve or a check valve in the sense that it stays closed when the flow direction is reversed. The particle catcher 200 further comprises filtering means 231 arranged at or near the outlet 230 to keep at least some a part of the entrained particles from exiting the flow channel 220 through the outlet 230. In the illustrated embodiment, the particle trapper further comprises an (optional) reservoir 225 for containing particles extracted from the fluid comprising entrained particles by the filtering means 231. The reservoir 225 may be a portion of the enclosure 220 that is at least partially delimited from the main volume of the enclosure 220. Alternatively, or in combination therewith, a magnet 223 or magnetized portion may be provided in the particle catcher. When in combination, the magnet 223 or magnetized portion may be arranged in the reservoir 225, as is shown at FIG. 6. In one example, one or more of the structures defining the reservoir 225, for example all or a portion of the below-discussed sidewall 213, wall 222, part 240, may be magnetized. The magnet 223 may also be attached to any of these structures. Multiple magnets 223 may also be utilized.

Without limitation, the filtering means 231 may comprise a screen, a mesh, or a sheet of non-woven material. The inventors have found that in the context of an axle, it is desirable to trap particles with sizes of 100 μm and greater (in practice, particle sizes may range up to a few mm). Accordingly, the size of the openings in the applied screen, mesh, or material is preferably less than 100 μm, and more preferably less than 90 μm, even more preferably less than 60 μm, and most preferably less than 40 μm.

In the illustrated embodiment, the enclosure 220 has a substantially elongate shape from the inlet 210 to the outlet 230. Optionally, the enclosure 220 is defined by at least a first cylindrically curved wall portion 221 and a second cylindrically curved wall portion 222, the first cylindrically curved wall portion 221 having a greater radius of curvature than the second cylindrically curved wall portion 222. It thus forms a bent or curved box. The first cylindrically curved wall portion 221 may be shaped so as to allow internal engagement with a cylindrical portion of an axle housing 100, although a position closer to the axis of the axle assembly is also possible.

The illustrated shape has been chosen to render the particle catcher sufficiently compact not to interfere with the flow of lubricant towards other parts that would need to be lubricated.

In the illustrated embodiment, the particle catcher 200 further comprising a bracket 290 adapted to attach the enclosure 220 to an inside of an axle housing 100 in an orientation whereby the inlet 210 is directed towards an upstream side of a prevailing fluid flow in the inside of the axle housing 100, as determined by the primary rotation direction of the axle.

FIG. 6 is a partly exploded perspective view of a particle catcher 200 according to an embodiment of the present invention. Unless indicated otherwise, the features previously described in the context of FIGS. 3-5 are also present in this embodiment, with the same function and technical effects.

In the illustrated embodiment, the trapping means comprises a support frame or grid 211 covering the cross-section of the flow channel 220, a fixed support 213, and a flap arranged to be movable between a closed position whereby it seals off the grid 211 and an open position whereby it rests against the fixed support 213. In the illustrated embodiment, the fixed support 213 is implemented as a permanent curved rib inside the housing.

The flap is preferably hingedly arranged so as to remain in the closed position under the influence of gravity (in the absence of a pressure differential) when the particle catcher is placed in its operational orientation (cfr. FIG. 2), and to move towards the open position (towards the fixed support) only when the pressure upstream of the inlet 210 exceeds the pressure inside the flow channel 220. The grid 211 keeps the flap 212 from rotating too far forward through the opening of the inlet 210.

The flap 212 itself may be substantially rigid (e.g., made of plastic or metal) or flexible (e.g., made of an elastomer). In the case of a flexible flap (not illustrated), the flap 212 may be arranged to be normally closed, and to open in the presence of an appropriate pressure differential by elastically deforming in the direction of the fixed support 213. If, accordingly, it would not be necessary to rely on the action of gravity to close the flap (elastic forces would return the flap 212 to its original shape whereby it covers the grid 211), the resulting constraint on the orientation of the particle catcher would not apply.

In the illustrated embodiment, the fixed support 213 is formed by a wall of the reservoir 225. As the trap is oriented so as to allow gravity to pull a flap 212 towards the closed position, particles caught inside the particle catcher 200 will also be pulled towards the inlet 210. The fixed support 213 is situated on the upstream side of the flow channel 220, and is therefore ideally positioned to keep particles inside the enclosure 220. The reservoir 225 is further delimited by walls of the enclosure 220, and open on the downstream side (i.e., the side closest to the outlet 230).

The trapping means may alternatively be formed by any other type of one-way valve or check valve that is capable of providing the same functions, as can easily be ascertained by the skilled person.

The enclosure 220 may comprise at least one removable part 240 situated so as to provide access to the reservoir 225. In the illustrated embodiment, the removable part 240 is a lid, secured by a screw or a bolt 245. When this lid is removed, for example during periodic servicing, the reservoir 225 may be emptied. As the filtering means 231 may get clogged over time, it is preferably also replaceable, and accessible upon removal of the lid. Finally, it may be useful to also provide access to a replaceable grid 211 and/or a replaceable flap 212, which may wear over time due to frequent impacts (for the grid 211) or frequent movement (for the flap 212).

While the invention has been described hereinabove with reference to specific embodiments, this was done to illustrate and not to limit the invention, the scope of which is determined by the attached claims.

1. A particle catcher comprising an enclosure defining a flow channel between an inlet and an outlet, the particle catcher further comprising:
a one-way valve, arranged at or near said inlet to allow a fluid comprising entrained particles to enter said flow channel through said inlet and to substantially prevent said fluid comprising entrained particles from exiting said flow channel through said inlet; and
a filter, arranged at or near said outlet to keep at least some of said entrained particles from exiting said flow channel through said outlet.

2. The particle catcher of claim 1, further comprising a reservoir for containing particles extracted from said fluid comprising entrained particles by said filter.

3. The particle catcher of claim 1, further comprising a magnetized element arranged to extract and immobilize particles comprising paramagnetic and/or ferromagnetic materials from said fluid comprising entrained particles.

4. The particle catcher of claim 1, wherein said one-way valve comprises a grid covering the cross-section of the flow channel, a fixed support, and a flap arranged to be movable between a closed position whereby said flap seals off said grid and an open position whereby said flap rests against said fixed support.

5. The particle catcher of claim 1, wherein said fixed support is formed by a wall of said reservoir.

6. The particle catcher of claim 1, wherein said filter comprises a screen, a mesh, or a sheet of non-woven material.

7. The particle catcher of claim 1, wherein said enclosure comprises at least one removable part situated so as to provide access to said reservoir.

8. The particle catcher of claim 7, wherein said removable part is secured by a screw or a bolt.

9. The particle catcher of claim 1, wherein said enclosure has a substantially elongate shape from said inlet to said outlet.

10. The particle catcher of claim 9, wherein said enclosure is defined by at least a first cylindrically curved wall portion and a second cylindrically curved wall portion, said first cylindrically curved wall portion having a greater radius of curvature than said second cylindrically curved wall portion.

11. The particle catcher of claim 10, wherein said first cylindrically curved wall portion is shaped so as to allow internal engagement with a cylindrical portion of an axle housing.

12. The particle catcher of claim 1, further comprising a bracket adapted to attach said enclosure to an inside of an axle housing in an orientation whereby said inlet is directed towards an upstream side of a prevailing fluid flow in said inside of said axle housing.

13. An axle assembly comprising:
an axle housing;
an axle rotatably arranged in said axle housing; and
at least one particle catcher according to claim 1, arranged in an orientation whereby said inlet is directed towards an upstream side of a prevailing fluid flow in said inside of said axle housing.

14. A particle catcher comprising:
an enclosure defining a flow channel extending between an inlet and an outlet;
a one-way valve located within the flow channel proximate the inlet, the one-way valve allowing a fluid comprising entrained particles to enter the flow channel through the inlet and preventing the fluid comprising entrained particles from exiting the flow channel through the inlet; and
a filter, arranged within the flow channel proximate the outlet to keep at least some of the entrained particles from exiting the flow channel through the outlet.

15. The particle catcher of claim 14, wherein the enclosure has a pair of curved wall portions at least partially defining the flow channel.

16. The particle catcher of claim 14, further comprising a reservoir for containing particles extracted from the fluid comprising entrained particles by said filter.

17. The particle catcher of claim 14, further comprising a magnetized element arranged to extract and immobilize some or all of the entrained particles.

18. The particle catcher of claim 14, wherein the one-way valve includes a grid covering a cross-section of the flow channel, a fixed support, and a flap arranged to be movable between a closed position whereby the flap seals off the grid and an open position whereby the flap rests against the fixed support.

19. An axle assembly comprising:
a) an axle housing;
b) an axle rotatably arranged in the axle housing; and
c) at least one particle catcher including:
1) an enclosure defining a flow channel;
2) a one-way valve located within the flow channel; and
3) a filter arranged within the flow channel downstream of the one-way valve;
d) wherein the particle catcher is arranged in an orientation such that the inlet is directed towards an upstream side of a prevailing fluid flow in the inside of the axle housing.

20. The axle assembly of claim 19, wherein the particle catcher includes a plurality of particle catchers.
